(19) United States
(12) Patent Application Publication
(10) Pub. No.: US 2026/0116546 A1
(43) Pub. Date: Apr. 30, 2026

(54) SIDE AIR OUTLET FOR AN AIRCRAFT CABIN AND AIRCRAFT WITH SIDE AIR OUTLET

(71) Applicant: Airbus Operations GmbH, HAMBURG (DE)

(72) Inventor: Jens LOHMAR, HAMBURG (DE)

(21) Appl. No.: 19/353,689

(22) Filed: Oct. 9, 2025

(30) Foreign Application Priority Data
Oct. 30, 2024 (DE) 102024131664.0

(51) Int. Cl. B64D 13/02; B64D 13/00

(52) U.S. Cl. CPC B64D 13/02; B64D 2013/003

(57) ABSTRACT

A lateral air outlet for an aircraft cabin, the interior space of the lateral air outlet being divided into two chambers. An air supply is connected to the first chamber, an air tapping point is connected to the first chamber, and at least one opening of the lateral air outlet is situated in the second chamber. An aircraft having a lateral air outlet of this type is also provided.

### CROSS-REFERENCES TO RELATED APPLICATIONS

This application claims the benefit of the German Patent Application No. 102024131664.0 filed on October 30, 2024, the entire disclosures of which are incorporated herein by way of reference.

### FIELD OF THE INVENTION

The present disclosure relates to a lateral air outlet for an aircraft cabin. The present disclosure relates, in particular, to a lateral air outlet for an aircraft, the interior space of the lateral air outlet being divided into two chambers, wherein an air supply is connected to the first chamber, an air tapping point is connected to the first chamber, and at least one opening of an air outlet is situated in the second chamber. The present disclosure also relates to an aircraft having a lateral air outlet of this type.

### BACKGROUND OF THE INVENTION

The supply of air to a passenger cabin in an aircraft is commonly provided via a plurality of air outlets. FIG. 7 shows, by way of example, a conventional air supply for a passenger cabin, which has a plurality of riser lines 50 via which air is conveyed from an underlying main line into the upper region of the passenger cabin (in particular, into a lateral region and ceiling region of the cabin). Connected to each of the riser lines 50 is a lateral air outlet 51, which commonly forms an air outlet which extends in the longitudinal direction of the aircraft and is situated in the lateral region of the passenger cabin. For example, the air may emerge from the lateral air outlets 51 below an overhead luggage compartment, that is to say, approximately in the region of the heads of the seated passengers. Furthermore, ceiling air outlets 52 may be connected to the riser lines 50, which ceiling air outlets correspondingly allow air to emerge above the overhead luggage compartments, for example in the region of a ceiling panel above an aisle in the passenger cabin.

Air outlets of a further type are so-called individual air outlets, which are arranged in the form of nozzles above the passenger seats. Here, it is common for each passenger seat to be assigned a nozzle, the nozzles being arranged, for example, in a (structural) group above a seat row. Such a nozzle group is commonly installed in a service channel (also referred to as personal service channel or PSC) and is part of a personal service unit (PSU) or individual service unit. The PSC and PSU are commonly arranged in the lower region of the overhead luggage compartments or adjacent thereto, such that they can be reached by the hands of the seated passengers, for example for the purposes of changing the direction of the outlet nozzle and/or opening or closing the outlet nozzle.

The individual air outlets are connected via a dedicated supply line 61 to the air supply of the aircraft. The supply line 61 commonly extends parallel to the service channel in order to enable the individual nozzle groups to be connected to the supply line 61 by means of a hose or the like.

The supply line 61 itself is supplied with fresh air via a dedicated riser line 60. The background to this is, in particular, that the static air pressure for the operation of the individual air outlets (nozzles) must be considerably higher than for the lateral air outlets 51 or ceiling air outlets 52. For example, the normal static air pressure of the individual air outlets (nozzles) is approximately 3 to 7 hPa, whereas it is only approximately 0.5 to 1 hPa in the case of the lateral air outlets 51 and ceiling air outlets 52. If a higher static pressure were used in the case of the lateral air outlets 51 and ceiling air outlets 52, the air flow in the passenger cabin would be too great. Owing to the high air flow rate through the lateral air outlets 51 and ceiling air outlets 52, a higher pressure would also lead to possibly audible and thus potentially unpleasant noises.

The present disclosure is therefore based on an object of improving an air supply system for the passenger cabin of an aircraft.

### SUMMARY OF THE INVENTION

According to a first aspect for improved understanding of the present disclosure, a lateral air outlet for an aircraft comprises a main body which extends in a longitudinal direction and encloses (forms) an interior space of the lateral air outlet, and at least one air outlet in the main body, the air outlet being designed to let air out of the interior space. The interior space is thus a volume which is enclosed by the main body and which serves for distributing air.

In the present disclosure, the lateral air outlet for an aircraft is to be understood to mean an air outlet which, in the lateral region of the passenger cabin, provides a general air supply to the passenger cabin. The lateral air outlet, or LAO, supplies fresh air to a portion of the passenger cabin as soon as the ventilation system is activated. The lateral air outlet is therefore not an individual air outlet such as a nozzle, which is adjustable by a passenger, in a PSU. The lateral air outlet can also be regarded as a passive air outlet. Furthermore, the lateral air outlet is arranged in the lateral region of the aircraft cabin, that is to say, differs from a ceiling air outlet which is arranged at a higher level, for example above an aisle in the aircraft or above overhead luggage compartments.

The lateral air outlet also comprises an inner separator, which divides the interior space of the main body into a first chamber and a second chamber. The divider of the interior space is to be understood as extending in the longitudinal direction of the main body. The background to this is that it is sought to generate, over the entire longitudinal extent of the lateral air outlet, a uniform air flow in a direction substantially perpendicular to the longitudinal direction of the main body. A structure of the lateral air outlet which is as uniform as possible in the longitudinal direction is necessary for this purpose. A division into two chambers which are arranged one behind the other in the longitudinal direction is therefore not what is meant. The longitudinal direction of the main body substantially corresponds to the longitudinal direction of an aircraft when the lateral air outlet is installed in an aircraft.

Furthermore, the lateral air outlet comprises an air inlet which is designed to be coupled to an air supply and which is arranged in a portion of the main body which delimits the first chamber. The air supply is an air line by which fresh air provided by a general ventilation system of the aircraft is conducted through the aircraft and distributed.

Merely by way of example, the air supply may be a riser line such as is already currently used in aircraft. Alternatively, the air supply/air line may also be arranged above the lateral air outlet, for example may branch off and lead downward from a main supply line extending in the ceiling region of the passenger cabin.

The lateral air outlet also comprises an air tapping point which is designed to be coupled to an individual air hose and which is arranged in a portion of the main body which delimits the first chamber. The individual air hose thus discharges air from the first chamber. The individual air hose is, in particular, a hose which supplies fresh air to at least one individual air outlet or to at least one individual air nozzle (or group of individual air outlets). This may be a conventional individual air outlet, as is known from use in a PSC (and/or in a PSU).

The first chamber of the lateral air outlet thus replaces the otherwise conventional supply line 61 (see FIG. 7). Also, by means of the lateral air outlet described here, it is possible to dispense with the dedicated riser line 60 of the conventionally used supply line 61. The lateral air outlet disclosed here thus makes it possible to simplify the entire ventilation system of the passenger cabin of the aircraft, and also saves weight.

The PSU is commonly arranged below or adjacent to an overhead luggage compartment, that is to say, in a region situated not far from the lateral air outlet. The individual air hose can thus be kept very short (or can have the hitherto conventional length). Installation is thus simplified, and the weight of the individual air hose is minimized.

The at least one air outlet of the lateral air outlet is arranged in a portion of the main body which delimits the second chamber, and the inner separator comprises at least one air passage which fluidically connects the first chamber to the second chamber. Fresh air is thus supplied to the second chamber via the at least one air passage, and the at least one air outlet (the opening, which forms the actual air outlet/air outlets, of the lateral air outlet) is fed with fresh air from the second chamber.

The at least one air outlet may be arranged in the main body such that the outflowing air flows out in a particular direction relative to the main body. Merely by way of example, the outflow direction of the air may be substantially perpendicular to a longitudinal axis of the main body. The main body can thus be installed in a space-saving manner in the longitudinal direction of the aircraft, while the air flows out in the transverse direction of the aircraft.

In one implementation variant, the inner separator may be designed to build up a first air pressure in the first chamber, wherein the at least one air outlet is designed to build up a second air pressure in the second air chamber. The first pressure is higher than the second pressure. In other words, the inner separator with the at least one air passage forms a pressure reducer within the main body of the lateral air outlet.

Thus, owing to the two chambers, the lateral air outlet can be used for a plurality of functions. Firstly, fresh air is conducted to the at least one air outlet, where a relatively low static air pressure in the second chamber, which is optimized for the at least one air outlet, can prevail. Noises at the at least one air outlet can thus be avoided owing to the optimized pressure. Secondly, fresh air in the first chamber is distributed in the longitudinal direction of the main body and is conducted both to the air tapping point (the individual air hose) and to the second chamber. Since a relatively high pressure prevails in the first chamber, which is optimized, in particular, for the supply of fresh air to the individual nozzles, it is possible to dispense with separate riser lines and supply lines. Owing to the longitudinal extent of the main body, there is also sufficient space available for dimensioning and arranging the at least one air passage of the inner separator such that no (disturbing) noise is generated as flow passes through the at least one air passage.

In one implementation variant, a cross-sectional area of the at least one air passage may be smaller than a cross-sectional area of the at least one air outlet. The cross-sectional area may also be the sum of all cross-sectional areas if a plurality of air passages and/or a plurality of air outlets are provided. Owing to the relatively small cross-sectional area of the at least one air passage, a higher pressure is built up in the first chamber than in the second chamber. If circular holes or passages are used, the cross-sectional area corresponds to the diameter of the air passage or of the air outlet. Use may self-evidently also be made of other cross-sectional shapes, or cross sections which vary over the length of the air passage or of the air outlet, in order to set the relevant static air pressure in the first and in the second chamber.

In one implementation variant, a number of air passages may be less than a number of air outlets.

In one implementation variant, a length (channel length) of the at least one air passage may be greater than a length (channel length) of the at least one air outlet. The greater the length, the greater the flow resistance, whereby a greater pressure is built up upstream of the air passage or the air outlet in the air flow direction.

It is self-evidently possible for all parameters (for example number of openings, opening diameter/cross-sectional area and length) of the at least one air passage and of the at least one air outlet to be set such that the two static air pressures in the first and in the second chamber are optimally set. In the case of a plurality of air passages or air outlets, all in the particular group may have the same parameters, or may vary. In other words, different air passages and/or different air outlets may be implemented in the same air outlet.

In particular, the length (in the air flow direction) and the diameter/cross-sectional area of the air passage or of the air outlet influence a generation of noise as flow passes through. To minimize the generation of noise, these two parameters may, in one implementation variant, be optimized for the least possible noise generation, while the relevant pressure is built up in the first and in the second chamber by means of the number of air passages or air outlets.

The first air pressure and the second air pressure can be set most easily in the two chambers of the lateral air outlet by means of the respective numbers of air passages or air outlets.

In one implementation variant, the inner separator may comprise a plurality of air passages. In particular, the plurality of air passages may be arranged along the longitudinal direction of the main body. In other words, the inner separator also extends along the longitudinal direction of the main body, for example over the same length as the interior space of the main body, wherein the plurality of air passages is distributed (that is to say, distributed in the longitudinal direction) over the inner separator.

In one implementation variant, the plurality of air passages may be provided in the form of a plurality of channels or holes in a separating wall. The separating wall thus forms the inner separator, which is penetrated or perforated by the plurality of channels or holes.

In one implementation variant, the main body may comprise a plurality of air outlets. In particular, the plurality of air outlets may be arranged along the longitudinal direction of the main body (along the second chamber). In other words, the second chamber also extends along the longitudinal direction of the main body, for example over the same length as the interior space of the main body, wherein the plurality of air outlets is distributed (that is to say, distributed in the longitudinal direction) over the length of the second chamber.

In one implementation variant, the plurality of air outlets may be provided in the form of a plurality of channels or holes in a wall of the main body. The wall of the main body thus delimits the air outlets.

The plurality of air outlets may self-evidently also be installed in the form of one or more components into the wall of the main body. Merely as an example, the main body may comprise a slot in the wall, into which slot the one or more components are inserted, wherein the component(s) has/have the plurality of air outlets.

In one implementation variant, the separating wall may comprise a plate with drilled through holes. In other words, the separating wall is a perforated plate, wherein the total cross-sectional area of the through holes allows the flow of air between the first and the second chamber.

In one implantation variant, the separating wall may comprise a plate having milled grooves or notches which form the plurality of air passages. Here, after the plate has been milled, the plate may be covered such that the grooves or notches form the air passages. Alternatively, the plate may be attached to a wall (including the top and bottom) of the main body such that the main body covers the grooves or notches and thus forms the air passages.

In one implementation variant, the separating wall may comprise a honeycomb plate which is locally compacted or broken in order to have a smaller thickness in parts, wherein the portions of smaller thickness form the plurality of air passages. The plate may be covered by another plate or may be attached to a wall of the main body, such that the air passages are formed in the portions of smaller thickness.

In one implementation variant, the separating wall may comprise a plate which is molded or cast so as to have an undulating shape. By virtue of the undulating plate being covered with a further plate or attached to a wall of the main body, some of the undulations form the plurality of air passages.

In one implementation variant, the separating wall may be arranged horizontally or vertically in the interior space. It is alternatively also possible for a first separating wall to be arranged horizontally, and for a second separating wall to be arranged vertically, in the interior space.

In one implementation variant, a width of the main body may be less than 15 cm, preferably less than 10 cm, and particularly preferably less than 7 cm.

In one implementation variant, a length of the main body may be between 50.8 cm and 152.4 cm (20 inches to 60 inches), preferably approximately 63.5 cm (25 inches) or 127 cm (50 inches).

In one implementation variant, a height of the main body may be between 4 cm and 30 cm, preferably between 4 cm and 15 cm, and particularly preferably between 5 cm and 10 cm.

In one implementation variant, a plurality of air tapping points may be arranged in that portion of the main body which delimits the first chamber. Here, each of the plurality of air tapping points may be designed to be coupled to an associated individual air hose. By means of the plurality of air tapping points, it is firstly possible for a plurality of individual air connections to be connected to the lateral air outlet. Secondly, it is also possible for the closest air tapping point to be used for the connection of an individual air hose, that is to say, for use to be made of individual air hoses which are as short as possible. It is self-evidently possible for air tapping points which are not used to be closed, for example by means of a cap or closure.

According to a second aspect for improved understanding of the present disclosure, an aircraft comprises a lateral air outlet according to the first aspect or at least one of the disclosed implementation variants.

The aircraft can thus be equipped with a weight-saving air-distributing system which is easy to install. It is self-evidently possible for a plurality of lateral air outlets to be arranged in the aircraft, for example along a passenger cabin (that is to say, in the longitudinal direction of the aircraft) in a lateral region. The lateral air outlets may be installed on both sides of the passenger cabin, such that fresh air can be supplied into the passenger cabin through the lateral air outlets from the left and from the right.

In one implementation variant, the aircraft may also comprise at least one passenger service unit which is coupled to the individual air hose. The passenger service unit may be arranged above passenger seats, for example below an overhead luggage compartment. Via an individual air hose, the passenger service unit can be connected to the fresh-air supply at the air tapping point. In particular, individual air outlets (nozzles) in the passenger service unit can be fluidically coupled to the individual air hose.

In one implementation variant, the aircraft may also comprise at least one air riser line which is fluidically connected to the air supply which is coupled to the air inlet. The air riser line may be supplied with fresh air from a ventilation system (of an air-conditioning installation) of the aircraft, such that the fresh air is conveyed via the air riser line into the main body of the lateral air outlet.

In one implementation variant, the aircraft may also comprise an air-distributing line which is fluidically connected to the air supply which is coupled to the air inlet. The air-distributing line may, for example, branch off from an upper region of the aircraft, in which a ventilation system (of an air-conditioning installation) or a portion thereof extends, and lead to the lateral air outlet, which is arranged further below. The air inlet of the lateral air outlet may, in this case, be provided in the upper region of the lateral air outlet.

The present disclosure is not restricted to the aspects and variants described here, in particular is not restricted to these in the sequence described. In particular, the description of the aspects and variants is not to be understood as a specific limitation to groups of features. Rather, combinations of the aspects and variants may also be formed which fall within the present disclosure. Thus, each variant, or each feature described as being optional, may be combined with any one of the other aspects or variants or combinations thereof.

### BRIEF DESCRIPTION OF THE DRAWINGS

The present disclosure will be described below on the basis of exemplary embodiments which are illustrated in the figures, in which:

FIG. 1 shows a schematic longitudinal section through a lateral air outlet;

FIG. 2 shows a schematic transverse section through a lateral air outlet;

FIG. 3 shows a schematic transverse section through an aircraft region having the lateral air outlet;

FIG. 4 shows a schematic transverse section through a further lateral air outlet;

FIGS. 5a and 5b show schematic transverse sections, FIG. 5c shows a schematic longitudinal section and FIG. 5d shows a perspective view of particular elements of a lateral air outlet;

FIG. 6 schematically shows a side view of an aircraft having lateral air outlets; and

FIG. 7 schematically shows a ventilation system according to the prior art.

### DETAILED DESCRIPTION OF THE PREFERRED EMBODIMENTS

The following description will discuss particular details for the purposes of explanation and not limitation, in order to impart a general understanding of the present disclosure. The present disclosure may self-evidently be implemented by means of other exemplary embodiments that depart from these particular details.

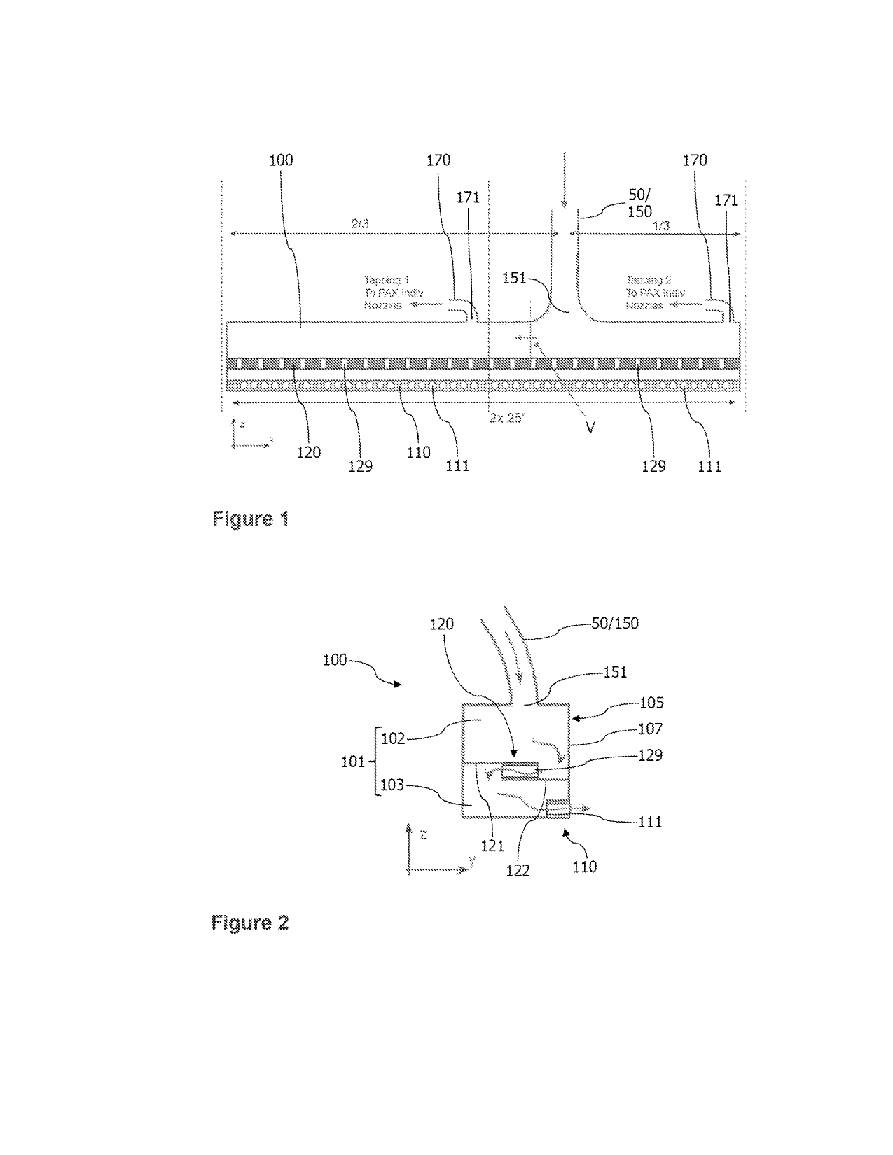

FIG. 1 shows a schematic longitudinal section through a lateral air outlet 100. FIG. 2 shows a schematic transverse section through a lateral air outlet 100, which may for example be the lateral air outlet from FIG. 1.

The lateral air outlet 100 comprises a main body 105 which extends in a longitudinal direction and encloses an interior space 101. The rectangular shape illustrated is merely an example. It is self-evidently possible for the lateral air outlet 100 to be rounded both in longitudinal section and in transverse section, or to be of trapezoidal, rhomboidal or similar design in transverse section.

The lateral air outlet 100 comprises an air inlet 151 which is designed to be coupled to an air supply 50, 150. The air supply may be any portion of a ventilation system, for example a riser line 50 or an air line 150 that is guided to the lateral air outlet 100 from above.

Although the air inlet 151 is illustrated on the top side of the lateral air outlet 100, the air inlet 151 may also be situated on a longitudinal end of the main body 105, on a bottom side, or on a side wall (for example the side wall x`).

The lateral air outlet 100 also comprises an inner separator 120, which divides the interior space 101 into a first chamber 102 and a second chamber 103. In the exemplary transverse section, the inner separator 120 is formed by two separating walls 121, 122. The inner separator 120 also comprises at least one air passage 129 which fluidically connects the first chamber 102 to the second chamber 103. As can be seen in particular from FIGS. 1 and 2, it is thus possible for fresh air that flows in via the air inlet 151 to be distributed in the first chamber 102, and to be conducted via the at least one air passage 129 into the second chamber 103.

The illustrated straight air passages 129 may self-evidently also have a curved or curving contour. In other words, in the transverse sectional view in FIG. 2, the air passage 129 may be downwardly or upwardly curved and/or have an undulating shape.

At least one air outlet 110 is arranged in a portion of the main body 105 which delimits the second chamber 103. The at least one air outlet 110 is designed to let air out of the interior space 101. The air outlet 110 is the actual air outlet, that is to say, the opening(s) from which the air can flow into the passenger cabin and is distributed. Merely by way of example, the at least one air outlet 110 may also deflect the air in a particular direction (in FIG. 2, for example, horizontally and substantially perpendicularly to the direction of longitudinal extent of the main body 105).

The lateral air outlet 100 also comprises an air tapping point 171 which is designed to be coupled to an individual air hose 170. The air tapping point 171 (also referred to as “Tapping”) is arranged in a portion of the main body 105 which delimits the first chamber 102.

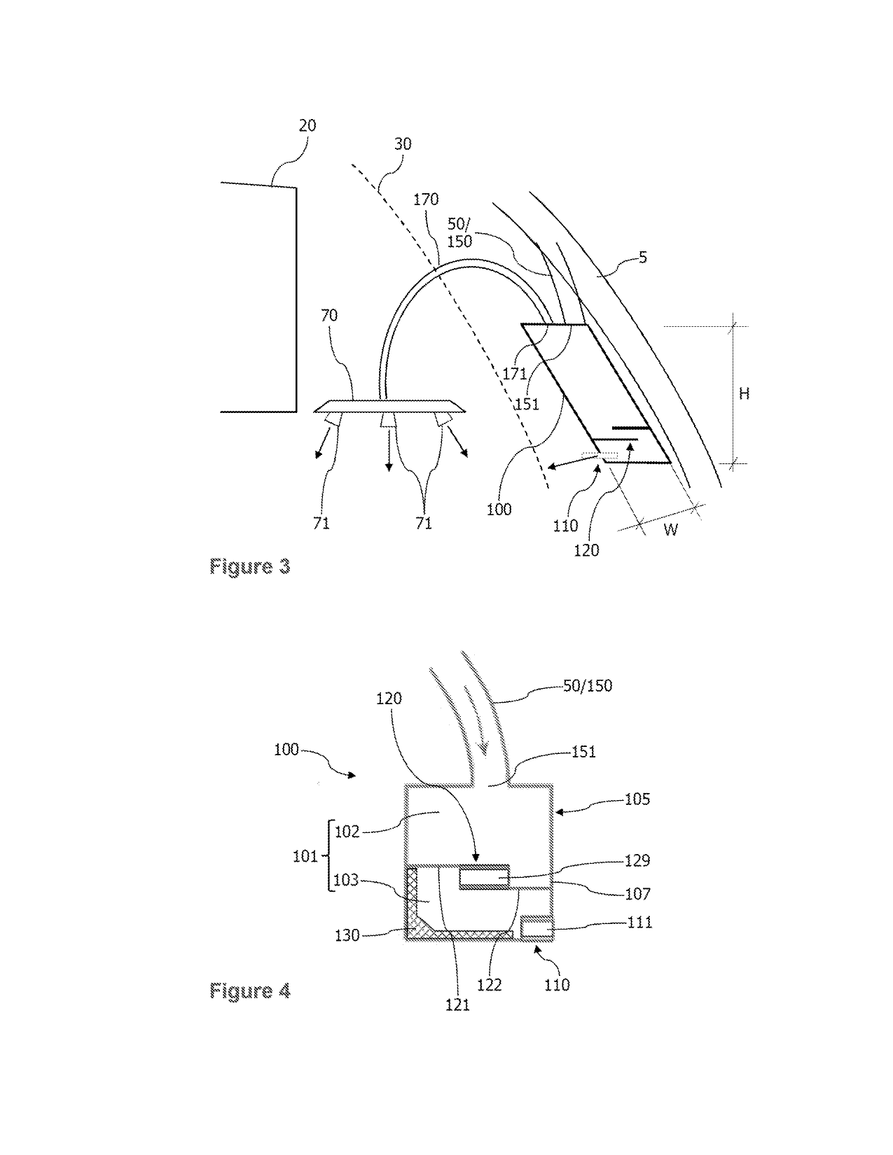

The air tapping points 171 and the individual air hose 170 discharge air from the first chamber 102. The individual air hose 170 is, in particular, a hose or a line which supplies fresh air to at least one individual air outlet 71 (FIG. 3) or to at least one individual air nozzle or group 70 of individual air outlets (also referred to as PAX Indiv Nozzles, that is to say, passenger individual nozzles, or simply passenger service unit). This may be a conventional individual air outlet 71, as is known from use in a PSC (and/or in a PSU).

As can be seen in particular from FIG. 1, the inner separator 120 may comprise a plurality of air passages 129, which are illustrated here in the form of channels of rectangular cross section. The air passages 129 are self-evidently limited neither in terms of length nor in terms of cross-sectional shape to the air passages 129 that are illustrated. Use may also be made of air passages 129 having an elliptical, round or polygonal cross section.

The same also applies to the air outlets 110, which may be provided in the form of a plurality of channels or holes 111. The illustrated round cross-sectional shape is intended here not to be limiting but merely as an example, and serves for ease of distinction from the air passages 129.

Merely by way of example, the channels or holes 111 of the air outlets 110 may be provided in a side wall 107 of the main body 105 which forms a portion of the second chamber 103.

The inner separator 120 may be designed to build up a first pressure in the first chamber 102. The at least one air outlet 110 may be designed to build up a second air pressure in the second chamber, wherein the first pressure is higher than the second pressure. In other words, the pressure in the first chamber 102, which originates from the air supply 50/150, is reduced to a lower pressure, which prevails in the second chamber 103.

Merely by way of example, the first and the second pressure may be built up in the respective chambers 102, 103 by means of the number and/or cross-sectional size of the air passages 129 and/or of the channels or holes 111.

The air passages 129 and/or the air outlets 110 may be provided in the form of one or more components which extend in the transverse direction of the main body 105 and form the corresponding channels 129, 111. In the case of a plurality of components, these may be installed in series in the longitudinal direction of the main body 105. It is alternatively also possible for a plate 121, 122 or wall 107 of the main body 105 to be perforated with holes in order to conduct air between the chambers 102, 103 and from the second chamber 103 into the passenger cabin.

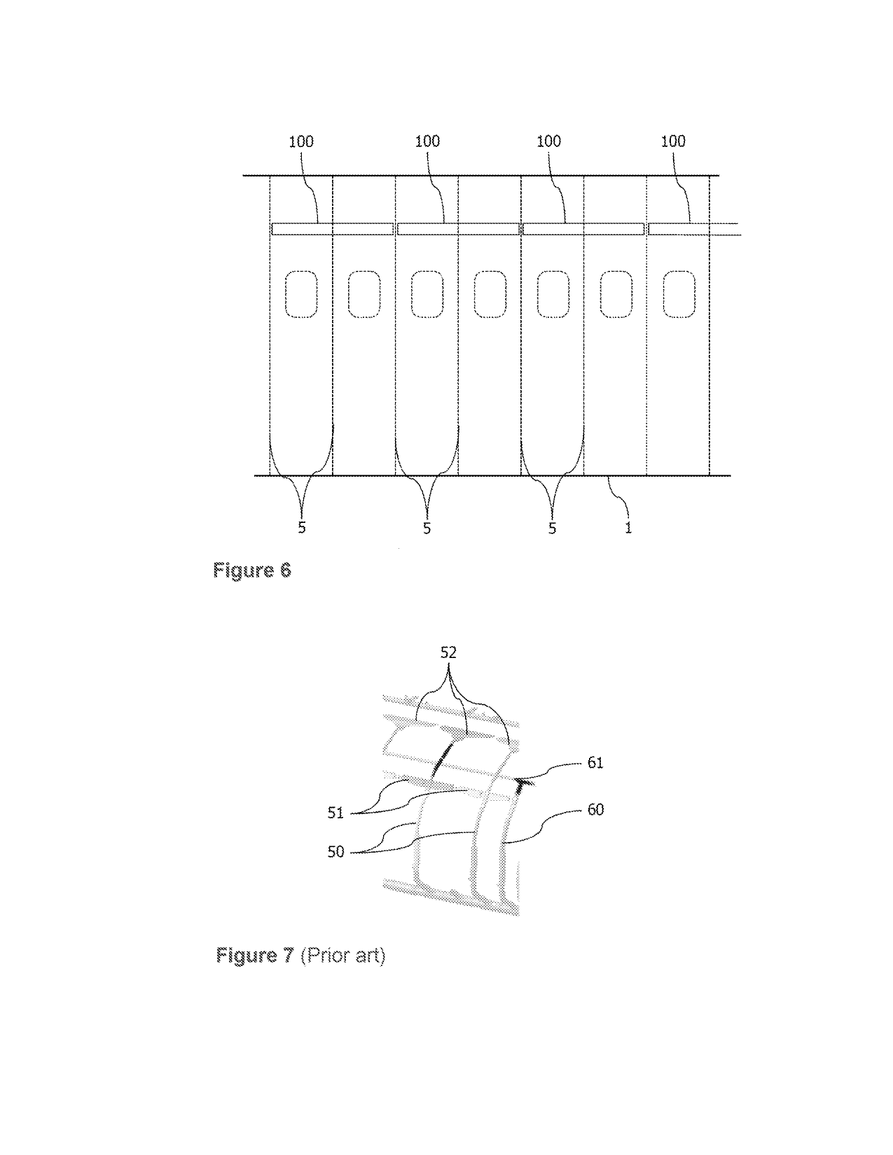

In FIG. 1, the lateral air outlet 100 is illustrated as covering two grid sections in a 25-inch (63.5-cm) grid. In other words, the main body 105 has a length of approximately 127 cm. The grid may, for example, relate to a standardized spacing of aircraft components, in particular a primary structural component such as a frame 5, for example (FIGS. 3 and 6). The main body 105 of the lateral air outlet 100 may self-evidently also be of some other length.

In the exemplary embodiment, the air inlet 151 is arranged in a region of the main body 105 which does not correspond to the middle (in the longitudinal direction). Rather, in the example illustrated, the air inlet 151 is arranged approximately one-third of the way along the length of the main body 105. This allows a greater number of air tapping points 171 to be installed on an identical grid to the aircraft components, for example of 25 inches (63.5 cm).

The grid described here may also be the minimum seat spacing between two seat rows in the aircraft. If the air tapping points 171 are provided in the lateral air outlet 100 on the same grid, it is easily possible for a group 70 of individual air outlets (that is to say, passenger individual nozzles) to be installed above each seat row and connected to the ventilation system of the aircraft. Air tapping points 171 that are not required can be closed, for example by means of caps, closures or the like.

FIG. 3 shows a schematic transverse section through an aircraft region having the lateral air outlet 100. The lateral air outlet 100, or the main body 105 thereof, can be adapted to the installation environment. For example, the lateral air outlet 100 may be installed in a triangular region between a frame 5 of the aircraft and the rear side of an overhead luggage compartment 20. To be able to be integrated in this space in as space-saving a manner as possible, the main body 105 of the lateral air outlet 100 may have a trapezoidal cross section. The cross section of the main body 105 may alternatively also be triangular, rhomboidal, elliptical or the like. Furthermore, at least a part of the main body 105 may project into a region between the frames 5.

The illustrated trapezoidal cross-sectional shape makes it possible for the main body 105 to be designed with a width of less than 15 cm, preferably less than 10 cm and particularly preferably less than or equal to 7 cm. The height of the main body 105 may be between 4 cm and 30 cm, preferably between 4 cm and 15 cm, and particularly preferably between 5 cm and 10 cm.

In particular, the narrow width of the main body 105 makes it possible for a plurality of lateral air outlets 100 to be provided in a continuous arrangement along the passenger cabin of the aircraft (see also FIG. 6) without blocking other fixtures in the passenger cabin. It can be clearly seen in FIG. 3 that sufficient space is available behind the overhead luggage compartment 20.

However, in one (longitudinal) portion of the aircraft, monuments (such as kitchens, toilets etc.) may be installed instead of overhead luggage compartments 20. In FIG. 3, a dashed line is used to illustrate, merely by way of example, the rear wall of a monument 30. Since such monuments 30 do not require individual air outlets or similar fixtures (of a PSU), the triangular region is commonly filled by the monument (at least for the most part, as shown by the dashed line 30). By installing a narrow lateral air outlet 100, this can be led through behind the monument 30. A space of approximately 7 to 10 cm is commonly available between the monument 30 and the frame 5.

The spacings illustrated in FIG. 3 are self-evidently not shown to scale, but are intended merely to reflect the basic arrangement of the luggage compartment 20, monument 30, and lateral air outlet 100.

As can also be seen from FIG. 3, the individual air hose 170 may be connected to a group 70 of individual air outlets 71, which are, for example, arranged above a passenger seat row. Monuments 30 also comprise individual air outlets 71, for example in a toilet or at an on-board kitchen. As can be seen in the schematic view in FIG. 3, the individual air hose 170 can also be easily routed into the monument 30 such that individual air outlets 71 provided therein can be connected in the same way as the group 70 of individual air outlets 71 above a seat row.

In conventional aircraft installations, the supply line 61 for the individual air outlets 71 is commonly interrupted in the region of monuments 30. In the present disclosure, the lateral air outlet 100 can also be led through behind monuments 30, such that the aircraft cabin can be flexibly configured or reconfigured at any time.

FIG. 4 shows a schematic transverse section through a further exemplary lateral air outlet 100. This corresponds substantially to the variant from FIG. 2. To reduce possible generation of noise in the lateral air outlet 100, a silencer 130 is provided. For example, the silencer 130 may be installed on a side wall, a top wall and/or a base of the main body 105. Since the noise is most likely to be generated in the pressure-reducing flow through the air passages 129, a simple silencer 130 may be provided on the side wall of the second chamber 103 and on the base of the main body 105 (and thus on the base of the second chamber 103). The silencer 130 may be implemented, for example, by means of a foam or a surface coating in the main body 105 (in particular, in the second chamber 103).

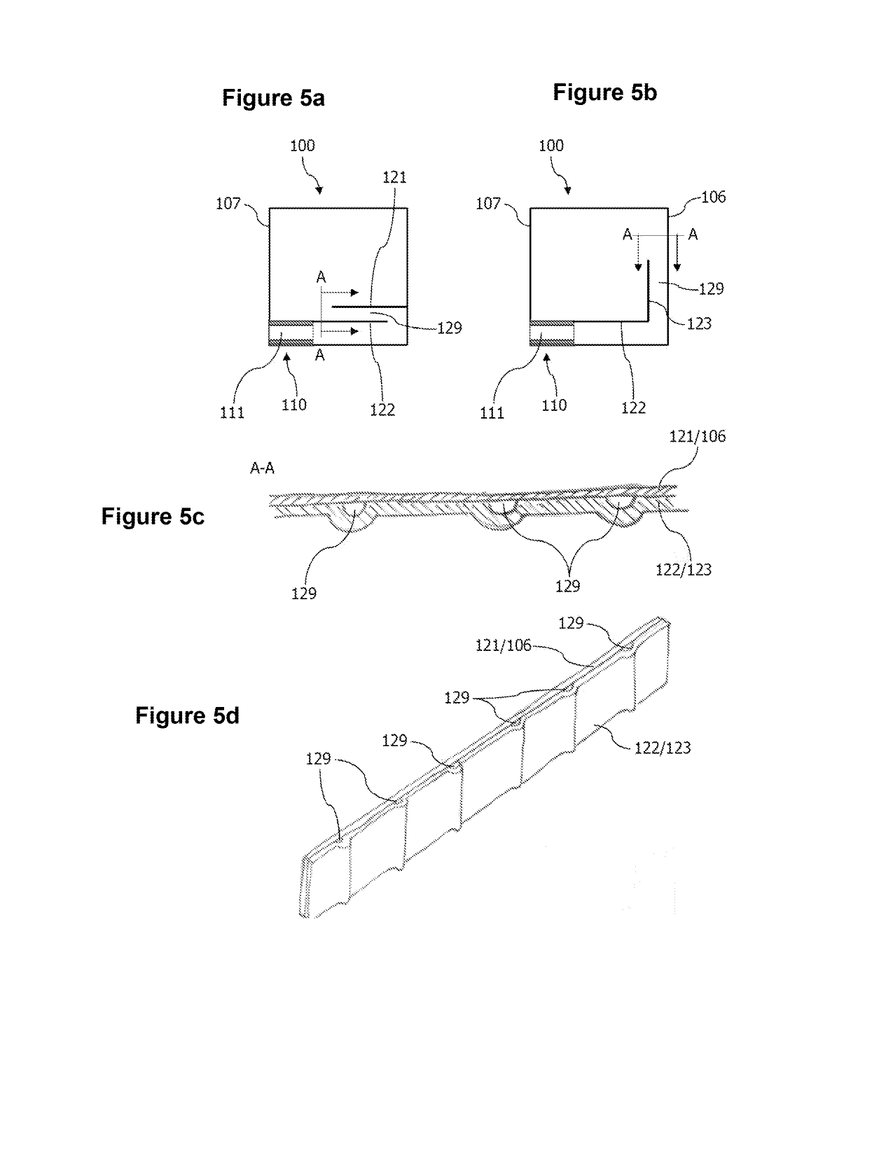

FIGS. 5a and 5b schematically show exemplary transverse sections, FIG. 5c shows a schematic longitudinal section and FIG. 5d shows a perspective view of particular elements of a lateral air outlet 100. In FIG. 5a, the air outlet 110 is arranged with its openings 111 on the opposite side to that in FIGS. 2 and 4. The inner separator 120 (in this case comprising separating walls 121, 122 and air passages 129) is also installed in a reversed arrangement.

In FIG. 5b, the inner separator 120 is provided along a side wall 106 of the main body 105. The separating wall 123 extends parallel to the side wall 106 and, with this, forms a space for the air passage(s) 129.

In both cases, the second chamber 103 is thus considerably smaller than, for example, in the variants according to FIGS. 2 and 4.

FIGS. 5c and d show a simple type of embodiment of the air passages 129. The air passages 129 are formed between/by two wall(s) in which recesses for the air passages 129 are provided. The walls may, on the one hand, be separating walls 121, 122 which form the inner separator 120 (see, for example, FIG. 5a). Alternatively, they may be a wall 106 of the main body 105 and an additional separating wall 123 (see, for example, FIG. 5b).

Here, one of the walls 121, 106 may be flat/smooth, while the other wall 122, 123 has recesses or protuberances for the air passages 129. The recesses may be formed by drilling holes, milling channels or notches, compacting or breaking portions of a honeycomb plate, or producing a plate which is molded or cast so as to have an undulating shape (as in FIGS. 5c and 5d).

FIG. 6 schematically shows a side view of an aircraft 1 having lateral air outlets 100. The aircraft 1 may, for example, have a multiplicity of frames 5 which are arranged in the transverse section of the aircraft 1. The lateral air outlets 100 may, for example, be arranged between two such frames. In the example shown in FIG. 6, there is always one lateral air outlet 100 arranged between two frames 5 with one frame 5 arranged in between. In other words, one lateral air outlet 100 spans two frame intervals. This allows easy and fast installation of the lateral air outlets 100 throughout the entire passenger cabin of the aircraft 1.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. A lateral air outlet for an aircraft, comprising:
a main body which extends in a longitudinal direction and encloses an interior space of the lateral air outlet;
at least one air outlet in the main body, said air outlet being configured to let air out of the interior space,
an inner separator, which divides the interior space into a first chamber and a second chamber;
an air inlet, which is configured to be coupled to an air supply and which is arranged in a portion of the main body which delimits the first chamber; and
an air tapping point, which is configured to be coupled to an individual air hose and which is arranged in a portion of the main body which delimits the first chamber; and
wherein the at least one air outlet is arranged in a portion of the main body which delimits the second chamber, and
wherein the inner separator comprises at least one air passage which fluidically connects the first chamber to the second chamber.

2. The lateral air outlet as claimed in claim 1,
wherein the inner separator is configured to build up a first air pressure in the first chamber,
wherein the at least one air outlet is configured to build up a second air pressure in the second air chamber,
wherein the first pressure is higher than the second pressure, and
wherein a cross-sectional area of the at least one air passage is smaller than a cross-sectional area of the at least one air outlet.

3. The lateral air outlet as claimed in claim 1, wherein at least one of
the inner separator comprises a plurality of air passages, or
the main body comprises a plurality of air outlets.

4. The lateral air outlet as claimed in claim 3, wherein the plurality of air passages comprise a plurality of channels or holes in a separating wall.

5. The lateral air outlet as claimed in claim 3, wherein the plurality of air outlets comprise a plurality of channels or holes in a wall of the main body.

6. The lateral air outlet as claimed in claim 3,
wherein the inner separator comprises a plate having drilled through holes or milled grooves or notches which form the plurality of air passages, or a honeycomb plate which is locally compacted or broken in order to have a smaller thickness, which forms the plurality of air passages, or a plate which is molded or cast so as to have an undulating shape, wherein some of the undulations form the plurality of air passages, and
wherein the inner separator is arranged horizontally or vertically in the interior space, or the inner separator comprises a first inner separator is arranged horizontally, and a second inner separator is arranged vertically, in the interior space.

7. The lateral air outlet as claimed in claim 1, wherein at least one of
a width of the main body is less than 15 cm, and/or
a length of the main body is between 50.8 cm and 152.4 cm, and/or
a height of the main body is between 4 cm and 30 cm.

8. The lateral air outlet as claimed in claim 7, wherein the width of the main body is less than 10 cm.

9. The lateral air outlet as claimed in claim 7, wherein the width of the main body is less than 7 cm.

10. The lateral air outlet as claimed in claim 7, wherein the length of the main body is approximately 63.5 cm or 127 cm.

11. The lateral air outlet as claimed in claim 7, wherein the height of the main body is between 4 cm and 15 cm.

12. The lateral air outlet as claimed in claim 7, wherein the height of the main body is between 5 cm and 10 cm.

13. The lateral air outlet as claimed in claim 1,
wherein a plurality of air tapping points is arranged in a portion of the main body which delimits the first chamber, and
wherein each of the plurality of air tapping points is configured to be coupled to an associated individual air hose.

14. An aircraft, comprising a lateral air outlet as claimed in claim 1.

15. The aircraft as claimed in claim 14, furthermore comprising at least one passenger service unit which is coupled to the individual air hose.

16. The aircraft as claimed in claim 14, furthermore comprising at least one air riser line which is fluidically connected to the air supply which is coupled to the air inlet.
